(19) United States
(12) Patent Application Publication
(10) Pub. No.: US 2023/0021921 A1
(43) Pub. Date: Jan. 26, 2023

(54) APPARATUS AND METHODS FOR PREPARING ALCOHOLIC BEVERAGES

(71) Applicant: Joseph Chi-Wei CHANG, Chino Hills, CA (US)

(72) Inventor: Joseph Chi-Wei CHANG, Chino Hills, CA (US)

(21) Appl. No.: 17/384,597

(22) Filed: Jul. 23, 2021

(51) Int. Cl. C12G 3/02; C12G 3/06

(52) U.S. Cl. CPC C12G 3/02; C12G 3/06

(57) ABSTRACT

Embodiments of the present disclosure relate to an apparatus and methods for preparing alcoholic beverages. In some embodiments, the apparatus includes a container, a sealing device, a first chamber, a second chamber disposed over the first chamber, and a plate disposed between the first and second chambers. The container, the sealing device, and the first chamber are sealingly connected, and the first chamber, the plate, and the second chamber are sealingly connected. The components form a closed system for an alcohol vapor to travel from the container to the second chamber without the risk of leaking out of the system.

### BACKGROUND

### Field

Embodiments disclosed herein relate to an apparatus and methods for preparing alcoholic beverages.

### Description of the Related Art

Conventional processes for making alcoholic beverages, such as distilled alcohol, include fermentation process, which is complex and time consuming. Furthermore, it is illegal in some jurisdictions to make distilled alcohol at home.

Therefore, there exists a need for improved apparatus and methods for preparing alcoholic beverages.

### SUMMARY

Embodiments of the present disclosure relates to apparatus and methods for preparing alcoholic beverages. In some embodiments, an apparatus for making an alcoholic beverage includes a first container, a first chamber disposed over the first container, a sealing device sealingly connecting the first container to the first chamber, a second chamber disposed over the first chamber, and a plate disposed between the first chamber and the second chamber. The first chamber, the plate, and the second chamber are sealingly connected. The apparatus further includes a cooling chamber and a cover enclosing the first container, the first chamber, the sealing device, the second chamber, the plate, and the cooling chamber.

In another embodiment, an apparatus for making an alcoholic beverage includes a first container, a first chamber disposed over the first container, a second chamber disposed over the first chamber, a plate disposed between the first chamber and the second chamber, a cooling chamber, a coolant chamber, a pump, a heat exchanger, and a cover enclosing the first container, the first chamber, the second chamber, the cooling chamber, the coolant chamber, the pump, and the heat exchanger.

In yet another embodiment, a method for preparing alcoholic beverages is provided. The method includes placing a first alcoholic beverage having a first alcohol concentration into a first container of an apparatus, heating the first alcoholic beverage to form a first alcohol vapor, flowing the first alcohol vapor through a plate, condense the first alcohol vapor to form a liquid on the plate, heating the liquid on the plate to form a second alcohol vapor, and condense the second alcohol vapor to form a second alcoholic beverage.

### BRIEF DESCRIPTION OF THE DRAWINGS

FIG. 1 is a perspective view of an apparatus for preparing alcoholic beverages, according to embodiments of the present disclosure.

FIG. 2 is a perspective view of the apparatus for preparing alcoholic beverages, according to embodiments of the present disclosure.

FIG. 3 is a cross-sectional side view of the apparatus, according to embodiments of the present disclosure.

FIG. 4 is a cross-sectional perspective view of the apparatus, according to embodiments of the present disclosure.

FIG. 5 is a perspective view showing components of the apparatus for preparing alcoholic beverages, according to embodiments of the present disclosure.

FIG. 6 is a perspective view showing components of the apparatus for preparing alcoholic beverages, according to embodiments of the present disclosure.

FIG. 7 is a side view of a disposable sack configured to be placed in a flavor basket of the apparatus, according to embodiments to the present disclosure.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

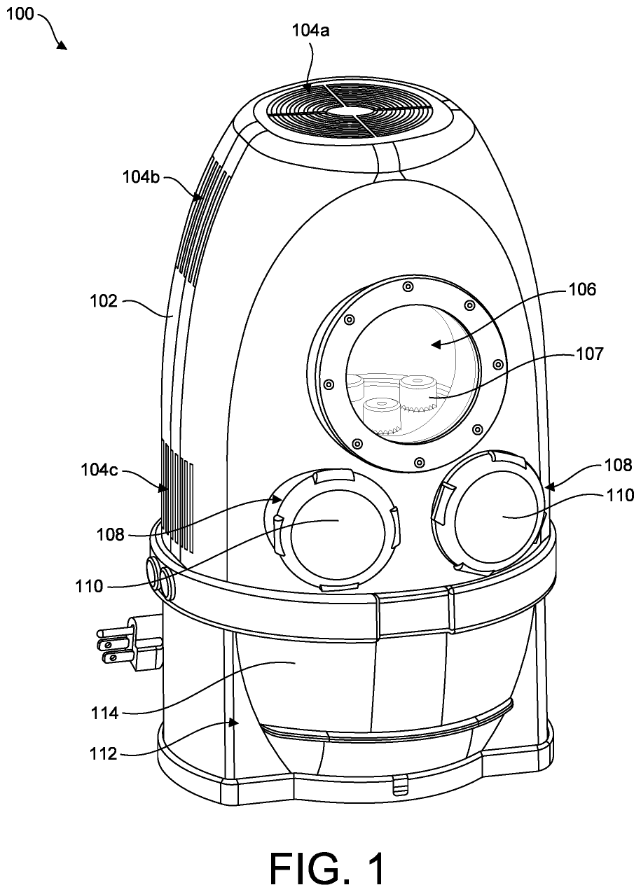

Embodiments of the present disclosure relate to an apparatus and methods for preparing alcoholic beverages. In some embodiments, the apparatus includes a container, a sealing device, a first chamber, one or more flavor baskets disposed in the first chamber, a second chamber disposed over the first chamber, and a plate disposed between the first and second chambers. The container, the sealing device, and the first chamber are sealingly connected, the first chamber and the one or more flavor baskets are sealingly connected, and the first chamber, the plate, and the second chamber are sealingly connected. The components form a closed system for an alcohol vapor to travel from the container to the second chamber without the risk of leaking out of the system. Various embodiments are discussed in greater detail below with respect to FIGS. 1 to 6.

FIG. 1 is a perspective view of an apparatus 100 for preparing alcoholic beverages, according to embodiments of the present disclosure. The apparatus 100 may be an alcoholic beverage machine. The apparatus 100 includes a cover 102 having openings 104a, 104b, 104c, 106, 108, 112 formed therein. The cover 102 may have dimensions suitable to be placed on a counter under cabinets in a residential home. In some embodiments, the cover 102 has a length ranging from about 10 inches to about 25 inches, such as from about 15 inches to about 20 inches; a bottom diameter ranging from about 8 inches to about 15 inches; and a top diameter ranging from about 5 inches to about 10 inches. In some embodiments, the cover 102 may have a frustum shape, as shown in FIG. 1. The cover 102 may have other suitable shapes. The cover 102 may be made of a plastic material for protecting the components disposed inside the cover 102.

The openings 104a, 104b, 104c may be formed in the cover 102 to remove heat generated within the cover 102. Each opening 104a, 104b, 104c may include a plurality of slit openings. For example, as shown in FIG. 1, the opening 104a formed in the top of the cover 102 includes a plurality of concentric half circular slit openings. The openings 104b and 104c each may include a plurality of rectangular slit openings.

The opening 106 may be formed in the cover 102 to allow a use to view the inside of the apparatus 100. A transparent material 107 may be formed in the opening 106. The transparent material 107 may be made of glass or other suitable transparent material. The openings 108 may be formed in the cover 102 for flavor baskets 110 to be inserted therein. As shown in FIG. 1, two openings 108 are formed in the cover 102 and two flavor baskets 110 are inserted in the openings 108. The number of openings 108 and flavor baskets 110 are not limited to two. In some embodiments, one or more openings 108 are formed in the cover 102, and one or more flavor baskets are disposed in the corresponding openings 108.

As shown in FIG. 1, the cover 102 may include an opening 112, and a pullout tray 114 is disposed in the opening 112. The openings 106, 108, 112 are sealed by any suitable means, so the internal components of the apparatus 100 may be airtight.

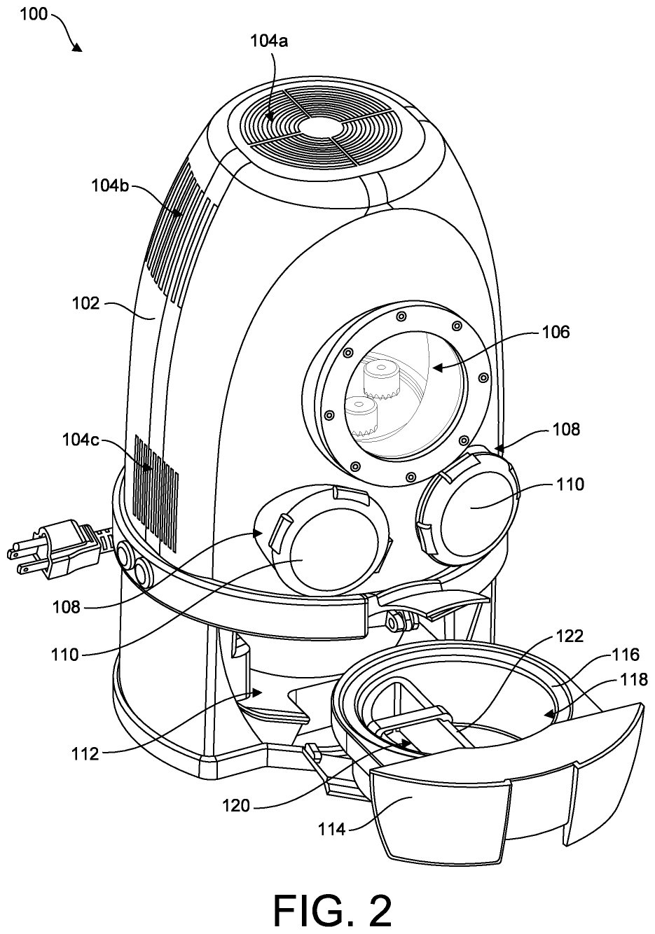

FIG. 2 is a perspective view of the apparatus 100 for preparing alcoholic beverages, according to embodiments of the present disclosure. As shown in FIG. 2, the pullout tray 114 is pulled out, and a container 116 is disposed in the pullout tray 114. The container 116 includes one or more compartments 118, 120. In some embodiments, the container 116 has a single compartment 118. In some embodiments, as shown in FIG. 2, the container 116 has two compartments 118, 120. In some embodiments, the two compartments 118, 120 are formed by placing another container 122 in the container 116, the container 122 defines the compartment 120, and the remaining portion of the container 116 not occupied by the container 122 defines the compartment 118. In some embodiments, the compartments 118, 120 are thermally separated. For example, the container 116 may include a thermally conductive material to define the compartment 118, and the container 122 may be include a thermally insulating material. Examples of the thermally conductive material include, but not limited to, copper, stainless steel, aluminum, or other suitable thermally conductive material. Examples of the thermally insulating material include plastic, silicone, or other suitable thermally insulating material. In some embodiments, the container 122 is attached to the side of the container 116, and the bottom of the container 122 is spaced apart from the bottom of the container 116. For example, a gap of about a few millimeters may be formed between the bottom of the container 122 and the bottom of the container 116 in order to prevent direct conduction of heat from the container 116 to the container 122. In some embodiments, the container 122 is not present in the container 116.

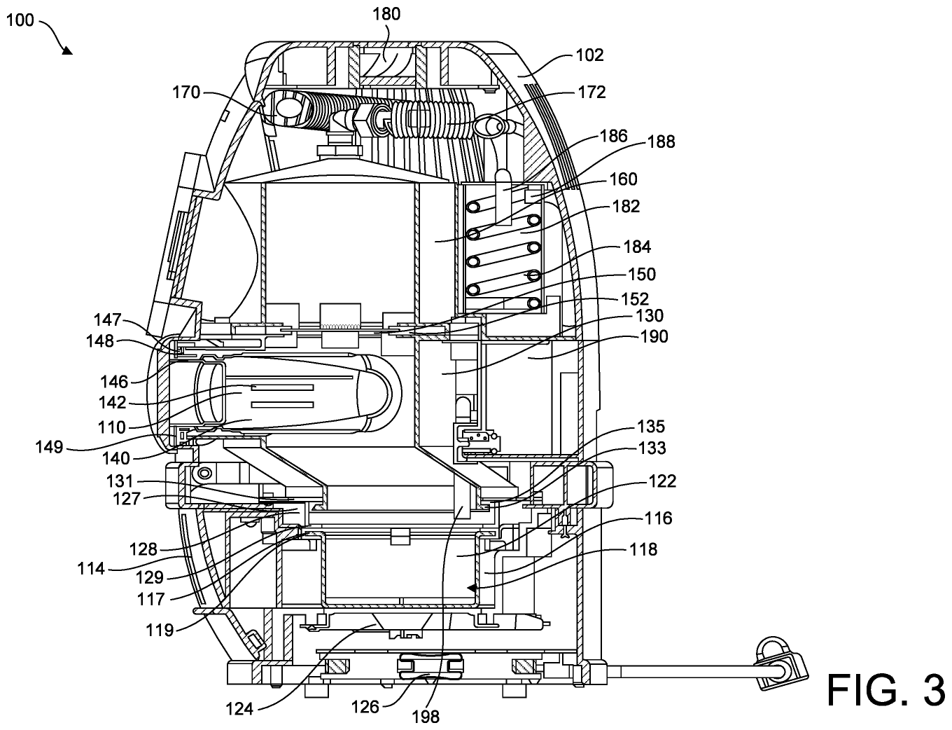

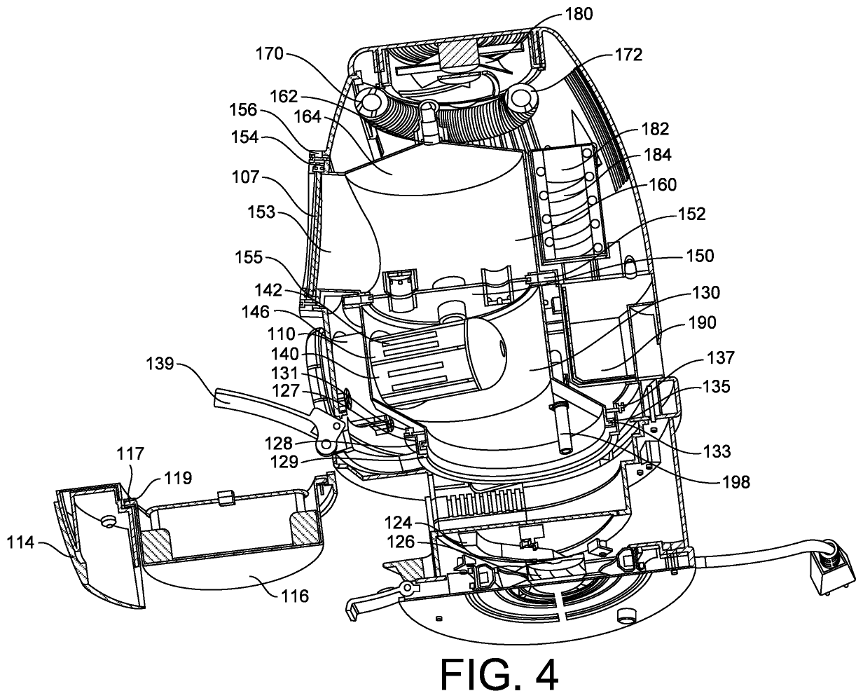

FIG. 3 is a cross-sectional side view of the apparatus 100, according to embodiments of the present disclosure. FIG. 4 is a cross-sectional perspective view of the apparatus 100, according to embodiments of the present disclosure. As shown in FIG. 3 and FIG. 4, the apparatus 100 may include a heating device 124 located under the pullout tray 114. The heating device 124 may be any suitable heating device. In some embodiments, the heating device 124 is a resistive heating element. The heating device 124 is configured to heat the content in the container 116. In some embodiments, the container 116 includes two compartments 118, 120, and the content in the compartment 120 may be thermally insulated from the compartment 118 due to the container 122. Thus, the heating device 124 may not heat the content in the container 122. A fan 126 may be disposed below the heating element 124 to help control the temperature of the content in the container 116.

In some embodiments, an alcoholic beverage, such as beer, wine, or distilled alcohol, for example, gin, rum, tequila, vodka, or whiskey, may be placed in the container 116. In the embodiments where the container 116 includes two compartments 118, 120, the distilled alcohol is placed in the compartment 118. An enhancer may be also placed in the container 116 with the alcoholic beverage. The enhancer may be any suitable material having one or more components that can be extracted by the alcoholic beverage at elevated temperatures. The enhancer may be a type of food, such as part of an herbal plant. For example, the enhancer may be ginseng, goji berry, cannabis plant, or other suitable type of food. The components of the material to be extracted by the alcoholic beverage at elevated temperature may be chemical compound, essence, flavor, or any suitable component.

In some embodiments, cannabis plant is placed in the container 116 or the compartment 118 of the container 116 with the distilled alcohol. The content in the container 116 or the compartment 118 of the container 116 is then heated to a temperature that the distilled alcohol vaporizes. In some embodiments, the content in the container 116 or the compartment 118 of the container 116 is heated to a temperature ranging from about 60 degrees Celsius to about 100 degrees Celsius, such as from about 70 degrees Celsius to about 80 degrees Celsius. The temperature may depend on the type of the alcoholic beverage in the container 116. If the alcoholic beverage is mostly water, for example beer or wine, then the alcoholic beverage may be heated to a temperature close to 100 degrees Celsius. If the alcoholic beverage contains over 20 percent alcohol by volume, such as 40 percent or higher, the alcoholic beverage may be heated to a temperature of about 80 degrees Celsius. The alcoholic beverage at the elevated temperature strips or extracts components from the cannabis plant. For example, cannabidiol (CBD) and/or tetrahydrocannabinol (THC) may be extracted from the cannabis plant. Thus, heating the alcoholic beverage with cannabis plant therein forms an alcohol vapor including CBD and/or THC. In some embodiments, the flavor of the cannabis plant is also extracted, and the alcohol vapor also includes the flavor of the cannabis plant.

As shown in FIGS. 3 and 4, a sealing device 128 is disposed above the container 116. Because the alcohol vapor is flammable, the components within the cover 102 form a closed system to prevent any leaking of the alcohol vapor. The sealing device 128 is movably disposed between the container 116 and a chamber 130. The sealing device 128 includes an annular member 131 attached to a cylindrical member 127. The cylindrical member 127 may include a horizontal portion 129 extending inwardly from the bottom of the cylindrical member 127. The horizontal portion 129 may have an annular shape. The annular member 131 and the cylindrical member 127 may be attached by any suitable device, such as a fastener 137, as shown in FIG. 4. The position of the sealing device 128 may be controlled by a handle 139, as shown in FIG. 4. For example, if the handle 139 is lifted, the sealing device 128 is at an upper position. If the handle 139 is lowered, the sealing device 128 is at a lower position. In some embodiments, when the sealing device 128 is at the upper position, the pullout tray 114 is free to move in and out of the apparatus 100. When the sealing device 128 is at the lower position, the pullout tray 114 is locked in the apparatus 100.

In some embodiments, when the pullout tray 114 is locked in the apparatus 100, the sealing device 128 is at the lower position so the horizontal portion 129 of the sealing device 128 is pressed against a seal 119, which is wrapped around a lip 117 of the container 116, as shown in FIG. 3. The lip 117 extends outwards at the top of the container 116. The seal 119 may be made of any suitable material, such as a polymer, plastic, or rubber. In some embodiments, the seal 119 is a gasket. At the lower position, the annular member 131 is pressed against another seal 135, which is wrapped around a lip 133 of the chamber 130. The lip 133 extends outwards at the bottom of the chamber 130. The seal 135 may include the same material as the seal 119. Thus, the container 116, the sealing device 128, and the chamber 130 are sealingly connected, and the alcohol vapor formed from the content in the container 116 would not leak out. The term “sealingly connected” may be used herein to describe a sealed connection between components.

In some embodiments, as shown in FIG. 4, the seal 135 protects the lip 133 from being contacted by the horizontal portion 129 of the sealing device 128 when the handle 139 is lifted to move the sealing device 128 to the upper position. The sealing device 128 and the chamber 130 may be made of a material that is resistant to corrosion from the alcohol vapor. In some embodiments, the sealing device 128 (i.e., the annular member 131 and the cylindrical member 127) and the chamber 130 are made of a metal, such as stainless steel, copper, or aluminum. In some aspects, copper or copper coated stainless steel is used for the sealing device 128 and the chamber 130, because copper may improve the flavor of the final product formed from the alcohol vapor.

As shown in FIGS. 3 and 4, one or more the flavor baskets 110 are inserted in the chamber 130. The flavor basket 110 includes a body 140 and a plurality of openings 142 formed in the body 140. In some embodiments, the body 140 is a wire mesh. The body 140 may be made of the same material as the chamber 130 because of the alcohol vapor exposure. Flavor additives, such as fruits, herbs, or any suitable additives, may be placed in the flavor basket 110. As the alcohol vapor flows through the body 140 of the flavor basket 110 via the openings 142, flavors from the flavor additives disposed in the flavor basket 110 are added to the alcohol vapor.

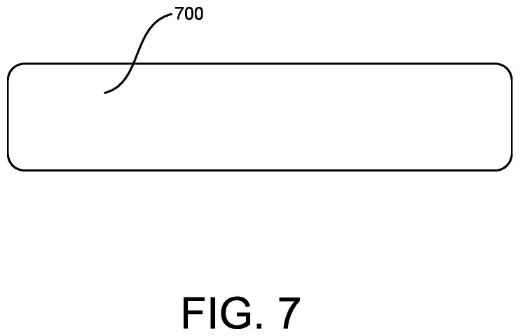

In some embodiments, as described above, the alcohol vapor includes CBD and/or THC and the flavor from the cannabis plant. A user may want to mask the flavor of the cannabis plant using a more desirable flavor, such as orange, strawberry, coconut, or other fruit flavors. Thus, the user can place pieces of orange, strawberry, coconut, or other suitable fruits into the flavor basket 110. As a result, the alcohol vapor passing through the flavor basket 110 can pick up the flavor of the flavor additives disposed in the flavor basket 110. In some embodiments, as shown in FIG. 7, a disposable sack 700 including premixed flavor additives is configured to be placed inside the flavor basket 110. The disposable sack 700 may have a shape conforming to the shape of the flavor basket 110 when filled with flavor additives. In some embodiments, the disposable sack 700 has a cylindrical shape when filled with flavor additives, as shown in FIG. 7. The disposable sack 700 may be made from a porous material to allow the alcohol vapor to pass through the disposable sack 700. As a result, flavors of the flavor additives disposed in the disposable sack 700 are added to the alcohol vapor. In some embodiments, the disposable sack 700 is made from fabric. In some embodiments, the disposable sack 700 is made from a nonwoven material.

In some embodiments, the body 140 of the flavor basket 110 is made from a flavor additive. For example, the body 140 of the flavor basket 110 may be made from wood, such as oak, apple, peach, or other suitable wood. In some embodiments, the alcoholic beverage disposed in the container 116 or the compartment 118 of the container 116 may be red wine or beer, and the alcohol vapor from the red wine or beer can pick up the wood flavor from the body 140 of the flavor basket 110.

As shown in FIGS. 3 and 4, the chamber 130 includes a portion 146 extending to the opening 108 formed in the cover 102. The portion 146 includes a lip 148 extending inward from an opening in the portion 146. A seal 147 is disposed between the lip 148 and a lip 149 of the body 140 of the flavor basket 110. The seal 147 may surround the lip 148. The flavor basket 110 and the portion 146 of the chamber 130 are sealingly connected. In other words, the seal 147 seals the gap between the flavor basket 110 and the portion 146 of the chamber 130, so no alcohol vapor can leak out at the interface between the portion 146 of the chamber 130 and the flavor basket 110. The seal 147 may be made of the same material as the seal 119.

As shown in FIGS. 3 and 4, a chamber 160 is disposed over the chamber 130, and a plate 150 is disposed between the chamber 130 and the chamber 160. A seal 152 may be wrapped around the edge of the plate 150, and the chambers 130, 160 are sealingly connected. In other words, the seal 152 seals the gap between the chamber 130 and the chamber 160, so no alcohol vapor can leak out at the interface between the chamber 130 and the chamber 160. The seal 152 may be made of the same material as the seal 119.

As shown in FIG. 4, the chamber 160 includes a portion 153 extending to the opening 106 formed in the cover 102. The portion 153 includes a lip 155 extending outward from an opening in the portion 153. The lip 155 is configured to receive the transparent material 107. A seal 154 may surround the edge of the transparent material 107, and the seal 154 is pressed against the lip 155 by a cover 156. The cover 156 may be attached to the cover 102 by any suitable device, such as a fastener. Thus, the transparent material 107 and the portion 153 of the chamber 160 are sealingly connected. In other words, the seal 154 seals the gap between the transparent material 107 and the portion 153 of the chamber 160, so no alcohol vapor can leak out at the interface between the portion 153 of the chamber 160 and the transparent material 107. The seal 1154 may be made of the same material as the seal 119.

The alcohol vapor carrying the components stripped or extracted from the enhancer and the flavors from the flavor additives in the flavor basket 110 flows through openings formed in the plate 150 into the chamber 160. Most of the vapor hits the ceiling 164 of the chamber 160 and condensates to form a liquid with an alcohol concentration higher than the alcohol concentration of the alcoholic beverage in the container 116 or the compartment 118 of the container 116. The liquid drops down to the plate 150 and gets vaporized again because the plate 150 is heated by the alcohol vapor. The alcohol vapor formed from the liquid collected on the plate 150 includes a higher alcohol concentration compared to the alcohol vapor upstream of the plate 150. The plate 150 helps to increase the alcohol concentration in the vapor. In some embodiments, the plate 150 is a bubble plate. In some embodiments, more than one plates 150 may be disposed in the apparatus 100 in order to increase the alcohol concentration in the alcohol vapor. The more concentrate alcohol vapor then exits the chamber 160 from an opening 162 formed in the ceiling 164.

As described above, the opening 106 (FIG. 1) and the transparent material 107 are used in order for a user to view the inside of the chamber 160. If the user does not see liquid dropping from the ceiling 164 of the chamber 160 onto the plate 150 and/or the liquid is not bubbling or boiling on the plate 150, then the apparatus 100 is not turned on or the heating device 124 may not be functioning correctly. Thus, the opening 106 formed in the cover 102 and the transparent material 107 help a user to confirm that the apparatus 100 is functioning correctly. The plate 150 and the chamber 160 may be made of the same material as the sealing device 128 and the chamber 130. In some embodiments, the plate 150 is made of copper.

As shown in FIGS. 3 and 4, a conduit 170 is connected to the opening 162. The conduit 170 may be a finned tube including a plurality of fins 172 extending from the tube. A fan 180 is disposed over the conduit 170. The alcohol vapor exiting the chamber 160 and entering the conduit 170 is cooled in the conduit 170 by the fan 180. A coiled conduit 184 is disposed in a cooling chamber 182 disposed downstream of the conduit 170. In some embodiments, as shown in FIGS. 3 and 4, the cooling chamber 182 is disposed adjacent the chamber 160. The coiled conduit 184 may be connected to the conduit 170 by a tube. The conduit 170, the coiled conduit 184, and the tube connecting the conduit 170 to the coiled conduit 184 may be made of the same material as the sealing device 128 and the chamber 130. In some embodiments, the coiled conduit 184 is made of copper.

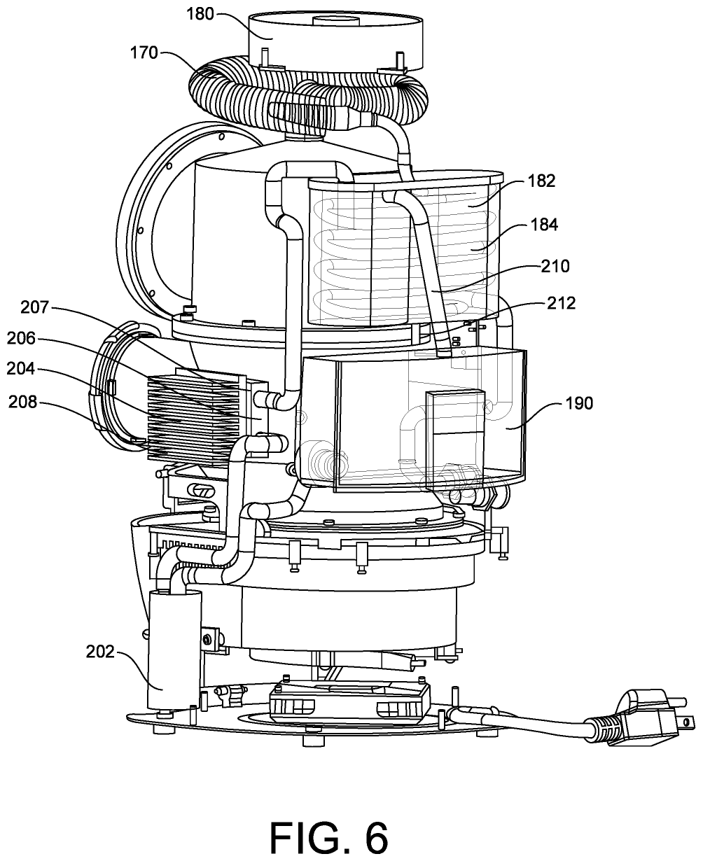

The cooling chamber 182 includes an inlet 186 and an outlet 188 for a coolant to flow in and out of the cooling chamber 182. The coolant may be stored in a coolant chamber 190 disposed below the cooling chamber 182. The coolant may be pumped to the cooling chamber 182 from the coolant chamber 190. The cooling chamber 182 and the coolant chamber 190 are described in detail in FIG. 6.

Most of the alcohol vapor may be turned to a liquid in the coiled conduit 184. The liquid, which include a higher alcohol concentration than the alcoholic beverage in the container 116, also includes components from the enhancer and flavors from the flavor baskets 110. The liquid flows to the container 116 from an outlet 198. In some embodiments, the container 116 includes a single compartment 118, and the liquid adds flavor and components from the enhancer to the original alcoholic beverage placed in the compartment 118 of the container 116. In some embodiments, the container 116 includes compartments 118, 120, and the liquid returns to the compartment 120. The liquid in the compartment 120 (or the container 122) includes a higher alcohol concentration than that of the alcoholic beverage initially placed in the compartment 118. The liquid in the compartment 120 also includes components stripped or extracted from the enhancer and flavor from the flavor additives in the flavor baskets 110. The liquid in the compartment 120 may be drink by a user or mixed with another drink.

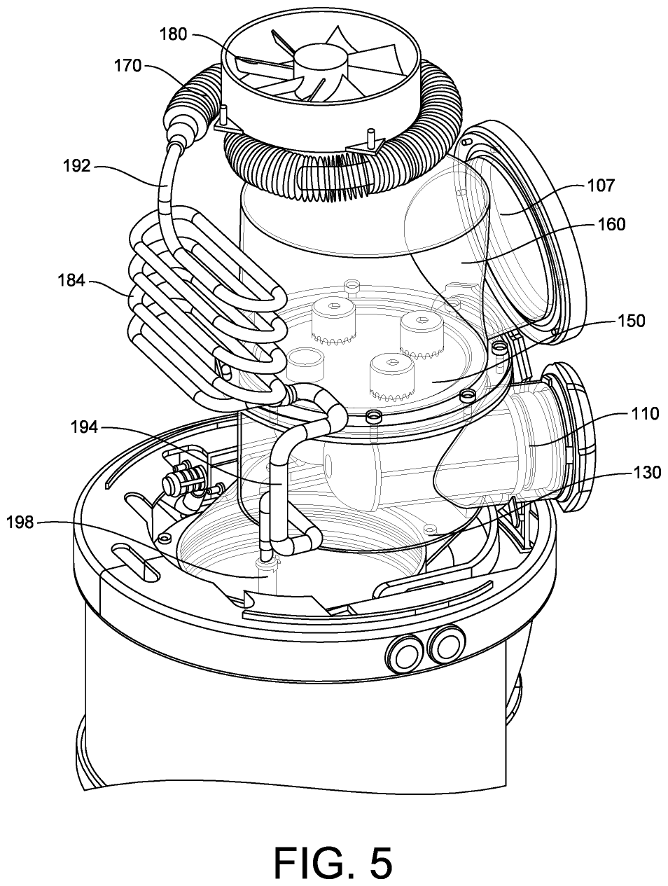

FIG. 5 is a perspective view showing components of the apparatus 100 for preparing alcoholic beverages, according to embodiments of the present disclosure. As shown in FIG. 5, the alcohol vapor travels from the container 116 (FIG. 2) to the chamber 130, through the plate 150 to the chamber 160, into the conduit 170, tube 192, and coiled conduit 184, through tubing 194, and into the container 116 from the outlet 198. The tubing 194 may include multiple segments of tubes to route the outlet 198 to be above the container 116 or the compartment 120 of the container 116. The container 116 (FIG. 2), the chamber 130, the plate 150, the chamber 160, and the conduit 170 form a closed system to ensure the alcohol vapor does not get leaked out of the system. The alcohol vapor may be turned to a liquid in the coiled conduit 184. The openings in the chamber 130 for the flavor baskets 110 to be inserted therein are sealed, and the opening in the chamber 160 for the transparent material 107 is also sealed.

FIG. 6 is a perspective view showing components of the apparatus 100 for preparing alcoholic beverages, according to embodiments of the present disclosure. The apparatus 100 includes a multi-stage cooling system. As described above, the apparatus 100 includes conduit 170 which may be a finned tube for heat dissipation, the fan 180 to remove heat from the conduit 170, and a cooling chamber 182 to further cool the alcohol vapor to turn into a liquid. The apparatus 100 further includes a pump 202 for pumping the coolant stored in the coolant chamber 190 to the cooling chamber 182. A heat exchanger 204 may be disposed between the pump 202 and the cooling chamber 182. The heat exchanger 204 may be used to cool the coolant. The heat exchanger 204 may include a metal block 206 having a channel formed therein, a thermoelectric cooling device 207, and a heat sink 208. The metal block 206 is in contact with the thermoelectric cooling device 207, which is in contact with the heat sink 208. The heat sink 208 may be made from a material having high thermal conductivity, such as a metal. The thermoelectric cooling device 207 may be any suitable cooling device, such as a Peltier device. The coolant flows through the metal block 206 and is cooled by the thermoelectric cooling device 207 in contact with the metal block 206. The temperature of the coolant at the outlet of the metal block 206 is lower than that of the coolant at the inlet of the metal block 206. The channel inside the metal block 206 may be “U” shaped or serpentine shaped. The side of the thermoelectric cooling device 207 in contact with the heat sink 208 may be at an elevated temperature due to the Peltier effect, and the heat sink 208 is utilized to cool the side of the thermoelectric cooling device 207.

The coolant may be any suitable coolant. In some embodiments, the coolant is water. During operation, the pump 202 continuously pumps the coolant from the coolant chamber 190 to the cooling chamber 182 through the heat exchanger 204. When the cooling chamber 182 is filled with the coolant, the coolant flows down to the coolant chamber 190 via the outlet 188 (FIG. 3) and the tube 210, and then gets pumped back into the cooling chamber 182 through the heat exchanger 204. As a result, coolant cooled by the heat exchanger 204 is continuously pumped into the cooling chamber 182 to cool the alcohol vapor/liquid flowing through the coiled conduit 184. The coolant chamber 190 may have a volume that is about 50 percent to about 200 percent greater than a volume of the cooling chamber 182 in order to recirculate the coolant in and out of the cooling chamber 182. The cooling chamber 182 may further include a drain 212 disposed at the bottom of the cooling chamber 182 and over the coolant chamber 190. The size of the drain 212 is substantially smaller than the inlet 186 (FIG. 3). Thus, a small amount of coolant maybe drained from the cooling chamber 182 to the coolant chamber 190 during operation, which does not affect the level of the coolant in the cooling chamber 182 due to the small size of the drain 212. When the operation is over and the pump 202 stops pumping the coolant into the cooling chamber 182, the coolant in the cooling chamber 182 drains to the coolant chamber 190 by gravity. As a result, the cooling chamber 182 remains dry when the apparatus 100 is not in use, which helps to keep the cooling chamber 182 clean.

Benefits of the present disclosure include an apparatus for preparing alcoholic beverages. The apparatus 100 is configured to turn a first alcoholic beverage to a second alcoholic beverage. The second alcoholic beverage may include substantially the same or different alcohol concentration. In some embodiments, the second alcoholic beverage includes a higher alcohol concentration than the first alcoholic beverage. By using the first alcoholic beverage as a starting point, traditionally more complex and time-consuming fermentation process to make alcoholic beverage is avoided. The apparatus 100 is also configured to add any components and/or flavor a user desires to in the second alcoholic beverage. Enhancers and flavor additives may be used to provide such components and/or flavors. The apparatus 100 makes it easy to prepare customizable alcoholic beverages. Furthermore, the apparatus 100 includes a closed system for the alcohol vapor formed therein, which minimizes the risk of leaking flammable alcohol vapor out of the apparatus 100.

While the foregoing is directed to embodiments of the disclosure, other and further embodiments of the disclosure thus may be devised without departing from the basic scope thereof, and the scope thereof is determined by the claims that follow.

1. An apparatus for making an alcoholic beverage, comprising:
a first container;
a first chamber disposed over the first container;
a sealing device sealingly connecting the first container to the first chamber;
a second chamber disposed over the first chamber;
a plate disposed between the first chamber and the second chamber, wherein the first chamber, the plate, and the second chamber are sealingly connected;
a cooling chamber; and
a cover enclosing the first container, the first chamber, the sealing device, the second chamber, the plate, and the cooling chamber.

2. The apparatus of claim 1, further comprising a conduit connected to an opening located on a ceiling of the second chamber.

3. The apparatus of claim 2, further comprising a coiled conduit disposed in the cooling chamber, wherein the coiled conduit is connected to the conduit.

4. The apparatus of claim 3, further comprising an outlet connected to the coiled conduit, wherein the outlet is disposed over the first container.

5. The apparatus of claim 4, further comprising a second container disposed in the first container, wherein the outlet is disposed over the second container.

6. The apparatus of claim 5, wherein the first container comprises a thermally conductive material, and the second container comprises a thermally insulting material.

7. The apparatus of claim 5, further comprising a heating device disposed under the first container.

8. The apparatus of claim 7, further comprising a first fan disposed under the heating device.

9. The apparatus of claim 8, further comprising a second fan disposed over the conduit.

10. An apparatus for making an alcoholic beverage, comprising:
a first container;
a first chamber disposed over the first container;
a second chamber disposed over the first chamber;
a plate disposed between the first chamber and the second chamber;
a cooling chamber;
a coolant chamber;
a pump;
a heat exchanger; and
a cover enclosing the first container, the first chamber, the second chamber, the cooling chamber, the coolant chamber, the pump, and the heat exchanger.

11. The apparatus of claim 10, further comprising one or more flavor baskets inserted in the first chamber, wherein the one or more flavor baskets extend through one or more first openings in the cover.

12. The apparatus of claim 11, further comprising a first seal disposed between each of the one or more flavor baskets and the first chamber.

13. The apparatus of claim 11, wherein each of the one or more flavor baskets includes a body having a plurality of openings.

14. The apparatus of claim 11, further comprising a transparent material covering an opening in the second chamber, wherein the transparent material is formed in a second opening in the cover.

15. The apparatus of claim 14, further comprising a second seal disposed between the transparent material and the second chamber.

16. The apparatus of claim 10, wherein the cover includes a plurality of slit openings.

17. A method for preparing an alcoholic beverage, comprising:
placing a first alcoholic beverage having a first alcohol concentration into a first container of an apparatus;
heating the first alcoholic beverage to form a first alcohol vapor;
flowing the first alcohol vapor through a plate;
condense the first alcohol vapor to form a liquid on the plate;
heating the liquid on the plate to form a second alcohol vapor; and
condense the second alcohol vapor to form a second alcoholic beverage.

18. The method of claim 17, further comprising:
placing an enhancer in the first container along with the first alcoholic beverage; and
extracting components from the enhancer.

19. The method of claim 18, further comprising flowing the first alcohol vapor through one or more flavor baskets, wherein the first alcohol vapor picks up flavor from flavor additives disposed in the one or more flavor baskets.

20. The method of claim 19, wherein the second alcoholic beverage is placed in a second container disposed in the first container.
